(19) United States
(12) Patent Application Publication
(10) Pub. No.: US 2026/0302896 A1
(43) Pub. Date: Oct. 1, 2026

(54) VEHICLE DRIVE DEVICE AND VEHICLE MOUNTED WITH SAME

(71) Applicant: Nissan Motor Co., Ltd., Yokohama-shi, Kanagawa (JP)

(72) Inventor: Takashi KURITA, Kanagawa (JP)

(21) Appl. No.: 19/480,411

(22) PCT Filed: May 19, 2023
(86) PCT No.: PCT/JP2023/018788

§ 371 Date: Oct. 31, 2025

(51) Int. Cl. H02K 11/33; B60K 1/00; B60K 11/04; H02K 5/22; H02K 9/19

(52) U.S. Cl. CPC H02K 11/33; B60K 11/04; H02K 5/225; H02K 9/19; B60K 1/00

(57) ABSTRACT

A vehicle drive device includes an electric motor, an inverter disposed above the electric motor, and a case that accommodates the electric motor and the inverter. The case includes a motor housing that accommodates the electric motor and has a top opening, and a lid-shaped inverter tray that is attached to the top opening of the motor housing and accommodates the inverter. An abutting surface between the motor housing and the inverter tray is sealed by a liquid gasket. The inverter tray has a flange extending outward on the abutting surface with the motor housing. The motor housing has a protruding portion extending outward to face the flange in a vicinity of the abutting surface with the inverter tray.

### CROSS-REFERENCE TO RELATED APPLICATIONS

This application is a U.S. national stage application of International Application No. PCT/JP2023/018788, filed on May 19, 2023.

### BACKGROUND

### Technical Field

The present invention relates to a vehicle drive device and a vehicle mounted with the same.

### Background Information

In the related art, a drive device in which an inverter and a motor for a vehicle are integrated is known. In such a drive device, for example, a lid-shaped tray (inverter tray) that accommodates the inverter is attached to a motor housing that accommodates the motor. During attachment, a gap between the inverter tray and the motor housing is sealed with an adhesive liquid gasket or the like for waterproofing.

When the inverter is to be replaced in a market, the inverter needs to be detached from the drive device in the drive device in which the inverter and an electric motor are integrated. However, if the gap between the inverter tray and the motor housing is sealed with a liquid gasket or the like, it may be difficult to detach the inverter from the drive device. In this regard, JP7076102B2 discloses that a photocurable silicone gel is used as a sealing material for waterproofing between a case body of a waterproof case for an automobile and a lid portion attached to the case body.

### SUMMARY

In the drive device in which the inverter and the motor are integrated, when photocurable silicone is used as a sealing material as described in JP7076102B2, the sealing material can be easily peeled off, and the inverter can be easily detached from the drive device. However, when the photocurable silicone is used, dedicated equipment is required, and therefore a cost may be increased.

The present invention has been made in view of the above problems, and an object thereof is to provide a vehicle drive device capable of easily detaching an inverter from the drive device while reducing a cost, and a vehicle mounted with the same.

One aspect of the present invention provides a vehicle drive device including an electric motor; an inverter disposed above the electric motor; and a case that accommodates the electric motor and the inverter. In the vehicle drive device, the case includes a motor housing that accommodates the electric motor and has a top opening, and a lid-shaped inverter tray that is attached to the top opening of the motor housing and accommodates the inverter, and an abutting surface between the motor housing and the inverter tray is sealed by a liquid gasket. The inverter tray has a flange extending outward on the abutting surface with the motor housing, and the motor housing has a protruding portion extending outward to face the flange in a vicinity of the abutting surface with the inverter tray.

### BRIEF DESCRIPTION OF DRAWINGS

Referring now to the attached drawings which form a part of this original disclosure, illustrative embodiments are shown.

FIG. 1 is a schematic configuration diagram illustrating a main configuration of a vehicle drive device according to an embodiment of the present invention.

FIG. 2 is an enlarged view of an abutting portion between an inverter tray and a motor housing.

FIG. 3 is an enlarged cross-sectional view of a protruding portion and a vicinity of the protruding portion.

FIG. 4 is a top perspective view of a case.

FIG. 5 is a diagram illustrating a vehicle mounted with the drive device.

### DETAILED DESCRIPTION OF EMBODIMENTS

Hereinafter, an embodiment of the present invention will be described with reference to the drawings and the like.

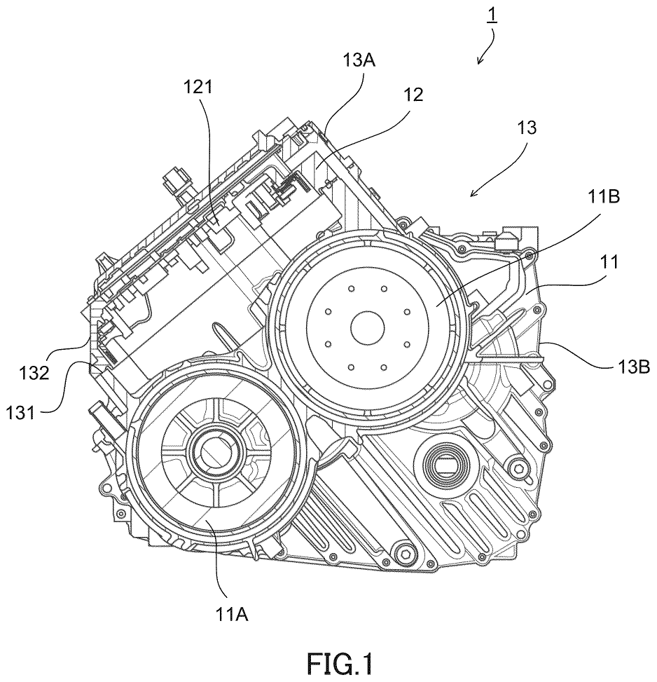

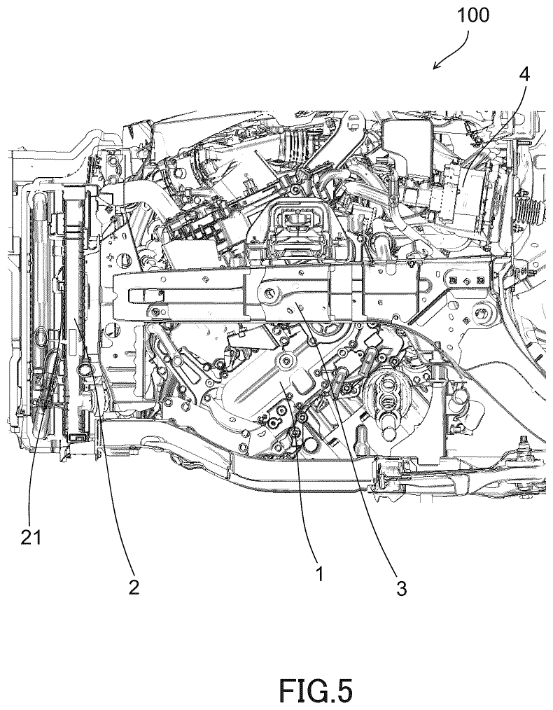

FIG. 1 is a schematic configuration diagram of a vehicle drive device (drive device) 1 according to an embodiment of the present disclosure, and is a cross-sectional view as viewed from a width direction of a vehicle mounted with the drive device 1. In the present embodiment, the drive device 1 is an electric power train (ePT) mounted on an electric vehicle (vehicle) 100 (see FIG. 5), and includes a generator (electric power generation motor) that is driven by an engine to generate electric power, and an electric motor (electric (drive) motor) that is driven by electric power from a battery to cause the electric vehicle 100 to travel. That is, the electric vehicle 100 mounted with the drive device 1 is a so-called series hybrid vehicle.

As illustrated in FIG. 1, the drive device 1 includes a rotary electric machine 11, an inverter (power conversion device) 12 disposed above the rotary electric machine 11, and a case 13 that accommodates the rotary electric machine 11 and the inverter 12. The drive device 1 receives supply of electric power from a battery (not illustrated) and drives an electric motor 11B of the rotary electric machine 11 to cause the electric vehicle 100 to travel. Note that in FIG. 1, a left direction is a front side of the electric vehicle 100, and a right direction is a rear side of the electric vehicle 100.

The rotary electric machine 11 includes a generator 11A, the electric motor 11B, and a drive machine housing (motor housing) 13B constituting a part of the case 13 described below. The generator 11A is an electric power generation motor driven by an engine (not illustrated) to generate electric power, and is, for example, a three-phase motor. The electric motor 11B is a drive motor (electric motor) that is driven by receiving supply of electric power from a battery (not illustrated) and rotates drive wheels via an axle of the electric vehicle 100, and is, for example, a three-phase motor. The electric motor 11B is rotated by the drive wheels during deceleration and the like of the electric vehicle 100, and generates regenerative electric power. That is, the electric motor 11B also functions as a generator. A motor housing 13B opens upward and accommodates the generator 11A and the electric motor 11B therein.

The inverter 12 includes electrical components 121 including a power module, a capacitor, and the like, and an inverter tray 13A constituting a part of the case 13 described below, and has a high voltage circuit built-in. The inverter 12 is disposed above the rotary electric machine 11 in a state of being inclined downward toward the front side of the electric vehicle 100. The inverter 12 is electrically connected to the rotary electric machine 11 (the generator 11A and the electric motor 11B), converts DC electric power output from the battery into AC electric power, supplies the AC electric power to the electric motor 11B, and drives the electric motor 11B. The inverter 12 converts the electric power generated by the generator 11A and the regenerative electric power from the electric motor 11B from AC electric power to DC electric power and supplies the DC electric power to the battery to charge the battery. The inverter tray 13A is formed to be lid-shaped and opened downward, and the electrical components 121 are disposed on an inner surface thereof.

The case 13 is made of metal such as aluminum, has a substantially rectangular shape, and is disposed such that one surface (front surface) thereof faces a front direction of the vehicle 100. The case 13 accommodates the rotary electric machine 11 (the generator 11A and the electric motor 11B) and the inverter 12. The case 13 includes the lid-shaped inverter tray 13A having the inner surface on which the electrical components 121 of the inverter 12 are disposed, and the motor housing 13B that opens upward and accommodates the rotary electric machine 11 (the generator 11A and the electric motor 11B). A tip of an outer edge portion of the inverter tray 13A and a tip of an outer edge portion of the motor housing 13B are abutted against and fixed to each other, so that the inverter tray 13A and the motor housing 13B constitute one case 13. An abutting surface 131 between the inverter tray 13A and the motor housing 13B is sealed by a formed-in-place gasket (FIPG) which is an adhesive liquid gasket. In this way, a waterproof property of the case 13 is enhanced.

Note that the case 13 has a chamfered portion 132 formed by chamfering a corner portion positioned at an upper portion on the front side (hereinafter, also simply referred to as a front upper portion) of the electric vehicle 100 into a cornered surface shape.

As described above, the drive device 1 is made by integrating the inverter 12 and the rotary electric machine (electric motor) 11, and the abutting surface 131 between the inverter tray 13A and the motor housing 13B is sealed by an adhesive liquid gasket.

When the inverter is to be replaced in a market, the inverter needs to be detached from the drive device in the drive device in which the inverter and an electric motor are integrated. However, if a gap between the inverter tray and the motor housing is sealed with an adhesive liquid gasket or the like for waterproofing, it may be difficult to detach the inverter from the drive device. On the other hand, when a photocurable silicone gel is used as a sealing material, the inverter can be easily detached, but a material cost thereof is higher than that of a liquid gasket such as FIPG, and dedicated irradiation equipment and electricity cost are required, which may increase the cost. Therefore, it is preferable to detach the inverter without using photocurable silicone or the like. Since the inverter is not frequently detached, it is preferable to detach the inverter without requiring dedicated equipment as much as possible from this point of view.

Therefore, in the present embodiment, on the abutting surface 131 between the motor housing 13B and the inverter tray 13A, the inverter tray 13A is provided with a flange 133 extending outward, and the motor housing 13B is provided with a protruding portion 134 extending outward in a manner of facing the flange 133. Accordingly, it is possible to easily peel off the liquid gasket (sealing material) between the inverter tray 13A and the motor housing 13B by inserting a bar or the like into a gap between the flange 133 and the protruding portion 134 facing the flange 133 and lifting the inverter tray 13A according to a principle of leverage. That is, the inverter 12 can be easily detached from the drive device 1 without using photocurable silicone or the like.

Hereinafter, a structure of the case 13 will be described in detail.

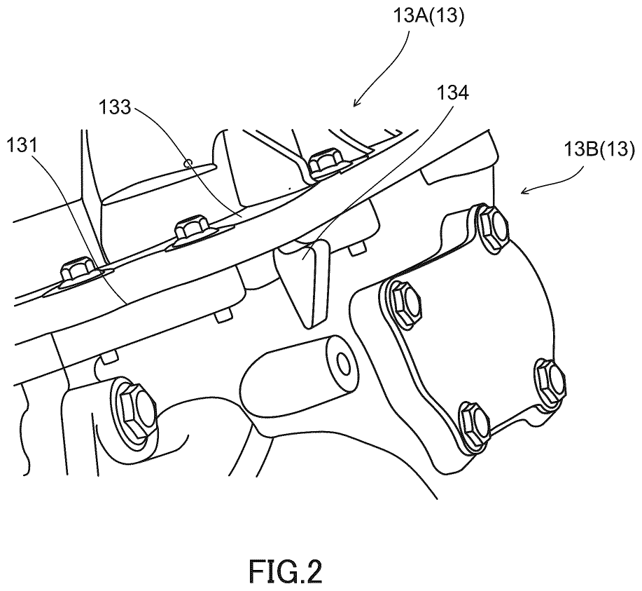

FIG. 2 is an enlarged view of an abutting portion between the inverter tray 13A and the motor housing 13B.

As described above, the case 13 includes the inverter tray 13A that accommodates the inverter 12, and the motor housing 13B that opens upward and accommodates the rotary electric machine 11 (the generator 11A and the electric motor 11B). As illustrated in FIG. 2, the flange 133 extending outward is formed at the tip of the outer edge portion of the inverter tray 13A, and the flange 133 and the tip of the outer edge portion of the motor housing 13B are abutted against each other and fastened by bolts or the like. In this way, the inverter tray 13A and the motor housing 13B constitute one case 13. Note that as described above, the abutting surface between the inverter tray 13A (flange 133) and the motor housing 13B is sealed by the liquid gasket FIPG.

The motor housing 13B is provided with the protruding portion 134 extending outward to face the flange 133 in a vicinity of the abutting surface 131 with the inverter tray 13A.

Note that one or more protruding portions 134 are provided on each side of the motor housing 13B. Here, since the case 13 is formed in a substantially rectangular shape and is disposed such that the front surface thereof faces the front direction of the vehicle 100, the protruding portion 134 is disposed at least on each of the front side, width direction sides, and a rear side of the vehicle 100.

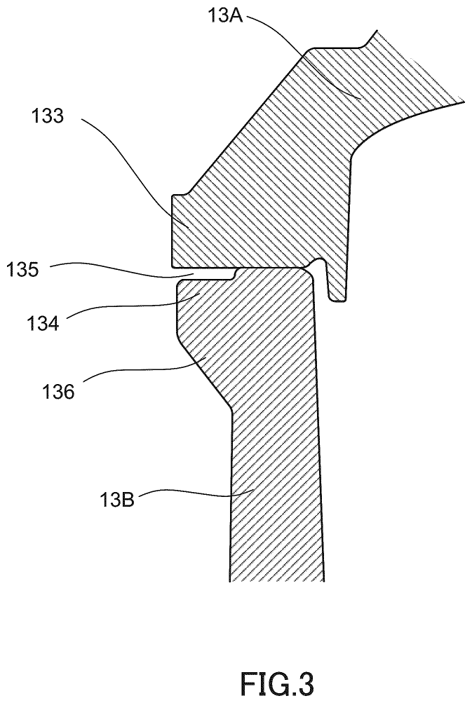

FIG. 3 is an enlarged cross-sectional view of the protruding portion 134 and a vicinity of the protruding portion 134.

As illustrated in FIG. 3, the protruding portion 134 is provided to face the flange 133, and a gap 135 is formed between the protruding portion 134 and the flange 133. Accordingly, when the inverter 12 is detached from the drive device 1, the liquid gasket (sealing material) between the inverter tray 13A and the motor housing 13B can be easily peeled off by inserting a bar or the like into the gap 135 and lifting the inverter tray 13A by the principle of leverage. That is, the inverter 12 can be easily detached from the drive device 1.

As illustrated in FIG. 3, a triangular rib 136 as a reinforcing rib is provided below the protruding portion 134. In this way, rigidity of the protruding portion 134 is enhanced. Note that in the present embodiment, the reinforcing rib is the triangular rib 136, but the reinforcing rib is not limited thereto as long as the rigidity of the protruding portion 134 can be increased.

Although not illustrated, the case 13 includes a locating portion constituted by a locating pin and a locating hole in the vicinity of the protruding portion 134. The locating portion positions the motor housing 13B and the inverter tray 13A. In this way, by providing the locating portion in the vicinity of the protruding portion 134, when the inverter 12 is detached from the drive device 1, a deviation between the motor housing 13B and the inverter tray 13A is prevented, and the detachment work is facilitated. Note that normally, it is preferable that the locating portion is set at two diagonal points on the inverter tray 13A in terms of balance, but in the present embodiment, as described above, the inverter 12 is inclined downward toward the front side of the electric vehicle 100. Therefore, when the inverter tray 13A is attached to or detached from the drive device 1, the inverter tray 13A is easily displaced, and the electrical components 121 mounted on the inner surface of the inverter tray 13A may interfere with the case 13 (motor housing 13B). Therefore, preferably, three or more locating portions are provided.

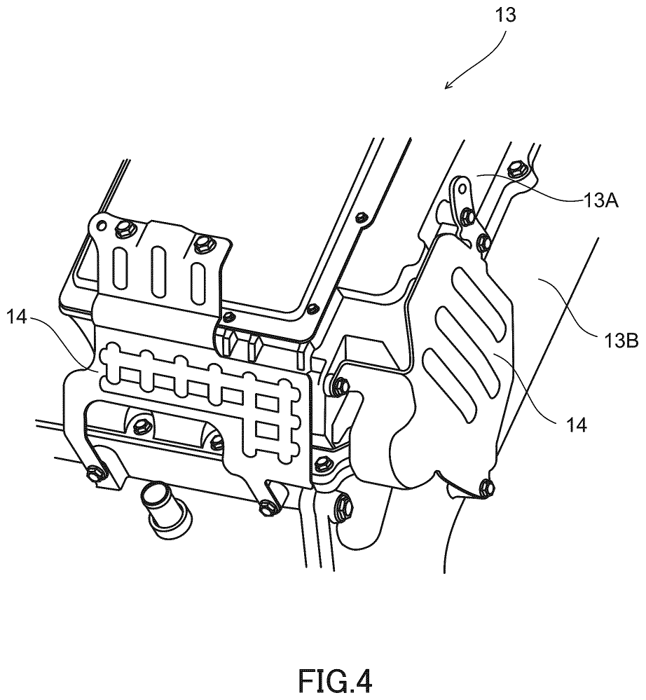

FIG. 4 is a top perspective view of the case 13.

As shown in FIG. 4, the case 13 is provided with a protector 14 to cover the protruding portion 134. The protector 14 is made of a metal plate such as an iron plate, covers the protruding portion 134, and is fixed to the case 13 in a detachable manner by bolts or the like (note that FIGS. 1 to 3 are views in a state in which the protector 14 is detached). Note that although FIG. 4 illustrates only the protectors 14 that cover the protruding portions 134 on the front side and the width direction sides of the vehicle 100, the protector 14 is also provided on the rear side of the vehicle 100 to cover the protruding portion 134 on the rear side of the vehicle 100.

Accordingly, since the protector 14 made of a metal plate is provided on the outer side of the protruding portion 134, when a component of the vehicle 100 interferes with the inverter tray 13A during a collision of the vehicle 100 or the like, the component first interferes with the protector 14. In this way, a collision energy is reduced, and the protector 14 interfering with the component interferes with the protruding portion 134, so that the collision energy to the inverter tray 13A is further reduced. Therefore, damage to the inverter tray 13A can be prevented. Further, as described above, since the rigidity of the protruding portion 134 is enhanced by the reinforcing rib 136, the collision energy to the inverter tray 13A can be received by the protruding portion 134 having high rigidity. Therefore, by providing the reinforcing rib 136 below the protruding portion 134, it is possible to further prevent the inverter tray 13A from being damaged.

Note that in the present embodiment, the protruding portion 134 on the front side, the width direction sides, and the rear side of the vehicle 100 are each covered by the protector 14, but the present invention is not necessarily limited thereto, and for example, only the protector 14 that covers the protruding portion 134 on the front side of the vehicle 100 may be provided. Even in this case, it is possible to prevent the inverter tray 13A from being damaged by the protector 14 and the protruding portion 134 during a head-on collision of the vehicle that generates the largest collision energy on the inverter tray 13A.

FIG. 5 is a side view of the front side of the electric vehicle 100 in which the drive device 1 is mounted on the electric vehicle 100.

As illustrated in FIG. 5, the drive device 1 is disposed on the front side of the electric vehicle 100, a radiator 2 is disposed in front of the drive device 1 in the vehicle 100, side members 3 are disposed on side surface sides of the vehicle 100 with respect to the drive device 1, and a brake booster 4 is disposed behind the drive device 1 in the vehicle 100.

The radiator 2 includes an electric fan and a fan motor 21 that drives the fan, and the fan motor 21 is disposed in front of the protruding portion 134 on the front side of the vehicle 100. Here, when the fan motor 21 having high rigidity interferes with the inverter tray 13A during a collision of the vehicle or the like, the inverter tray 13A may be damaged. However, in the drive device 1 of the present embodiment, the motor housing 13B includes the protruding portion 134 on the front side of the vehicle 100, and the protector 14 is provided to cover the protruding portion 134. The case 13 (inverter tray 13A) has a chamfered portion 132 formed by chamfering a corner portion at a front upper portion of the vehicle 100 into a cornered surface shape. Therefore, during a collision of the vehicle or the like, the fan motor 21 first interferes with the protector 14, and the protector 14 that has interfered with the component interferes with the protruding portion 134 whose rigidity is enhanced by the reinforcing rib 136. Therefore, the protector 14 reduces the collision energy to the inverter tray 13A, and the collision energy can be further received by the protruding portion 134 having high rigidity. Therefore, the inverter tray 13A is prevented from being damaged. In the case 13 (inverter tray 13A), since the corner portion of the front upper portion of the vehicle 100 is chamfered, the fan motor 21 is prevented from interfering with the corner portion and a load is prevented from being locally applied thereto. That is, the collision energy of the fan motor 21 can be dispersed, and the inverter tray 13A is further prevented from being damaged.

The side member 3 is disposed on the side surface sides of the vehicle 100 with respect to the drive device 1, that is, outside the protruding portions 134 disposed on the width direction sides of the vehicle 100.

The brake booster 4 is an electric booster, and is disposed behind the drive device 1 in the vehicle 100, that is, behind the protruding portion 134 on the rear side of the vehicle.

As described above, in the drive device 1, the motor housing 13B includes the protruding portion 134 on each of the front side, the width direction sides, and the rear side of the vehicle 100, and the protector 14 is provided to cover the protruding portion 134. Therefore, when the side member 3 and the brake booster 4 interfere with the inverter tray 13A during a collision of the vehicle or the like, the side member 3 and the brake booster 4 first interfere with the protector 14, and the protector 14 interfering with the side member 3 and the brake booster 4 further interferes with the protruding portion 134 whose rigidity is enhanced by the reinforcing rib 136. Therefore, the protector 14 reduces the collision energy to the inverter tray 13A, and the collision energy can be further received by the protruding portion 134 having high rigidity. Therefore, the inverter tray 13A is prevented from being damaged.

As described above, the fan motor 21 of the radiator 2, the side members 3, and the brake booster 4 are disposed in front of the protruding portion 134 on the front side of the vehicle 100, on outer sides of the protruding portions 134 on the width direction sides, and behind the protruding portion 134 on the rear side, respectively, so that it is possible to prevent the inverter tray 13A from being damaged during a collision of the vehicle or the like.

According to the vehicle drive device 1 of the above-described embodiment and the vehicle 100 mounted with the vehicle drive device 1, the following effects can be obtained.

The vehicle drive device 1 includes the case 13 including the motor housing 13B that accommodates the electric motor (electric motor) 11 and has a top opening, and the lid-shaped inverter tray 13A that is attached to the top opening of the motor housing 13B and accommodates the inverter 12, and the abutting surface 131 between the motor housing 13B and the inverter tray 13A is sealed by a liquid gasket. The inverter tray 13A has the flange 133 extending outward on the abutting surface 131, and the motor housing 13B has the protruding portion 134 extending outward to face the flange 133 in the vicinity of the abutting surface 131. As a result, the liquid gasket (sealing material) between the inverter tray 13A and the motor housing 13B can be easily peeled off according to the principle of leverage by inserting a bar or the like into the gap 135 between the flange 133 and the protruding portion 134 facing the flange 133. That is, the inverter 12 can be easily detached from the drive device 1 without using photocurable silicone or the like. Therefore, it is possible to provide the vehicle drive device 1 in which the inverter 12 can be easily detached from the drive device 1 while reducing the cost.

In the vehicle drive device 1, the case 13 has a rectangular shape, and the protruding portion 134 is provided in a number of at least one on each side of the motor housing 13B (case 13). As a result, the liquid gasket (sealing material) can be peeled off by lifting the inverter tray 13A from each direction using a bar or the like according to the principle of leverage. That is, the inverter 12 can be more easily detached from the drive device 1.

Further, since the protruding portion 134 is provided on each side of the case 13, even when components in the vehicle 100 interfere with the inverter tray 13A from each direction during a collision of the vehicle or the like, the collision energy from the components can be reduced by the protruding portion 134. That is, damage to the inverter tray 13A can be prevented.

In the vehicle drive device 1, the protruding portion 134 is disposed at least on the front side, the width direction sides, and the rear side of the vehicle 100. As a result, the inverter tray 13A can be lifted and the liquid gasket (sealing material) can be peeled off from the front, rear, left, and right directions of the vehicle 100 by using a bar or the like according to the principle of leverage. That is, the inverter 12 can be more easily detached from the drive device 1.

Since the protruding portion 134 is disposed on each of the front side, the width direction sides, and the rear side of the vehicle 100, even when the components in the vehicle 100 interfere with the inverter tray 13A from the front, rear, left, and right directions during a collision or the like of the vehicle, collision energy from the components can be reduced by the protruding portion 134. That is, damage to the inverter tray 13A can be prevented.

In the vehicle drive device 1, the case 13 includes the locating portion that positions the motor housing 13B and the inverter tray 13A in the vicinity of the protruding portion 134. As a result, when the inverter 12 is detached from the drive device 1, the deviation between the motor housing 13B and the inverter tray 13A is prevented, and the detachment work is facilitated.

In the vehicle drive device 1, the sealing material that seals the abutting surface 131 between the motor housing 13B and the inverter tray 13A is formed-in-place gasket (FIPG). That is, as the sealing material, the material cost is higher than that of a liquid gasket such as FIPG, and a photocurable silicone gel that requires dedicated irradiation equipment or electricity cost is not used. Therefore, the cost can be reduced.

In the vehicle drive device 1, the reinforcing rib 136 is provided below the protruding portion 134 of the motor housing 13B. In this way, the rigidity of the protruding portion 134 is enhanced. Therefore, when the components in the vehicle 100 interfere with the inverter tray 13A during a collision of the vehicle or the like, the components interfere with the protruding portion 134 whose rigidity is enhanced by the reinforcing rib 136. That is, the collision energy from the interfering with the components can be received by the protruding portion 134 having high rigidity. Therefore, the inverter tray 13A is further prevented from being damaged.

The vehicle drive device 1 includes the protector 14 made of a metal plate and provided on the case 13 to cover the protruding portion 134. Accordingly, when the components of the vehicle 100 interfere with the inverter tray 13A during a collision of the vehicle 100 or the like, the components first interfere with the protector 14. Accordingly, the collision energy is reduced. Since the protector 14 interfering with the components interferes with the protruding portion 134, the protruding portion 134 can receive the collision energy to the inverter tray 13A. Therefore, damage to the inverter tray 13A can be further prevented.

In the vehicle 100 mounted with the vehicle drive device 1, the fan motor 21 of the radiator 2 is disposed in front of the protruding portion 134 on the front side of the vehicle. Accordingly, when the fan motor 21 interferes with the inverter tray 13A during a collision or the like of the vehicle, the fan motor 21 interferes with the protruding portion 134 on the front side of the vehicle 100, and thus the collision energy to the inverter tray 13A is reduced. Therefore, the inverter tray 13A is prevented from being damaged.

In the vehicle 100 mounted with the vehicle drive device 1, the side members 3 are disposed outside the protruding portions 134 on the width direction sides of the vehicle. Accordingly, when the side members 3 interfere with the inverter tray 13A during a collision of the vehicle or the like, the side members 3 interfere with the protruding portions 134 on the width direction sides of the vehicle 100, and thus the collision energy to the inverter tray 13A is reduced. Therefore, the inverter tray 13A is prevented from being damaged.

In the vehicle 100 mounted with the vehicle drive device 1, the brake booster 4 is disposed behind the protruding portion 134 on the rear side of the vehicle. Accordingly, when the brake booster 4 interferes with the inverter tray 13A during a collision of the vehicle or the like, the brake booster 4 interferes with the protruding portion 134 on the rear side of the vehicle 100, so that the collision energy to the inverter tray 13A is reduced. Therefore, the inverter tray 13A is prevented from being damaged.

Note that in the present embodiment, the electric vehicle 100 on which the vehicle drive device 1 is mounted is a series hybrid vehicle, but is not limited thereto, and may be other hybrid vehicles, electric vehicles, or the like. The vehicle drive device 1 may be mounted on a vehicle other than an electric vehicle.

In the present embodiment, the rotary electric machine 11 accommodated in the case 13 includes the generator 11A and the electric motor (electric motor) 11B, but the present invention is not limited thereto, and for example, the rotary electric machine 11 accommodated in the case 13 may only include the electric motor (drive motor).

In the present embodiment, the case 13 has a substantially rectangular shape, but the present invention is not limited thereto, and the shape of the case 13 may be a polygon other than a rectangle or may not be a polygon.

As in the present embodiment, it is preferable that one or more protruding portions 134 are provided on each side of the motor housing 13B and provided on each of the front side, the width direction sides, and the rear side of the vehicle 100, but the present invention is not necessarily limited thereto. That is, the effect that the inverter 12 can be easily detached from the drive device 1 can be obtained when the protruding portion 134 is provided in a number of at least one on the motor housing 13B.

As in the present embodiment, it is preferable that the locating portion is provided in the vicinity of the protruding portion 134, but the present invention is not necessarily limited thereto, and the locating portion may not be provided.

In the present embodiment, the liquid gasket that seals the abutting surface 131 between the motor housing 13B and the inverter tray 13A is FIPG, but the present invention is not limited thereto, and other liquid gaskets may be used.

As in the present embodiment, the case 13 preferably includes the protector 14 that covers the protruding portion 134 and the reinforcing rib 136 below the protruding portion 134, but the present invention is not necessarily limited thereto, and the case 13 may not include the protector 14 and the reinforcing rib 136. Even in this case, as long as the motor housing 13B has the protruding portion 134, at least the effect that the inverter 12 can be easily detached from the drive device 1 can be obtained.

In the present embodiment, the fan motor 21 of the radiator 2 is disposed in front of the protruding portion 134 on the front side of the vehicle, the side members 3 are disposed outside the protruding portions 134 on the width direction sides of the vehicle, and the brake booster 4 is disposed behind the protruding portion 134 on the rear side of the vehicle, but the arrangement of each component in the vehicle 100 is not limited thereto.

In the present embodiment, the case 13 has the chamfered portion 132 formed by chamfering the corner portion at the front upper portion of the electric vehicle 100 into a cornered surface shape, but the present invention is not necessarily limited thereto, and the case 13 may not have the chamfered portion 132.

Although the embodiment of the present invention has been described above, the above embodiment merely exemplifies a part of application examples of the present invention and does not intend to limit the technical scope of the present invention to the specific configurations of the above embodiments.

1. A vehicle drive device, comprising:
an electric motor;
an inverter disposed above the electric motor; and
a case that accommodates the electric motor and the inverter, wherein
the case is polygonal, and includes a motor housing that accommodates the electric motor and has a top opening, and a lid-shaped inverter tray that is attached to the top opening of the motor housing and accommodates the inverter,
an abutting surface between the motor housing and the inverter tray is sealed with a liquid gasket,
the inverter tray has a flange extending outward from the abutting surface with the motor housing,
the motor housing has a protruding portion extending outward in a vicinity of the abutting surface with the inverter tray in a manner of facing the flange,
the protruding portion is provided in a number of at least one on each side of the motor housing, and is at least disposed on each of a front side, width direction sides, and a rear side of a vehicle mounted with the vehicle drive device,
the vehicle drive device is disposed on the front side of the vehicle mounted with the vehicle drive device,
a radiator is disposed in front of the vehicle drive device in the vehicle, a side member is disposed on a side surface of the vehicle with respect to the vehicle drive device, and
a brake booster is disposed behind the vehicle drive device in the vehicle.

2. (canceled)

3. (canceled)

4. The vehicle drive device according to claim 1, wherein
the case has a locating portion for positioning the motor housing and the inverter tray in a vicinity of the protruding portion.

5. The vehicle drive device according to claim 1, wherein
the liquid gasket is a formed-in-place gasket.

6. The vehicle drive device according to claim 1, further comprising:
at least one of a reinforcing rib or a protector, wherein
the reinforcing rib is provided below the protruding portion of the motor housing, and
the protector is made of a metal plate and is provided on the case to cover at least the protruding portion on the front side of the vehicle.

7. A vehicle mounted with the vehicle drive device according to claim 1, wherein
a radiator fan motor is disposed in front of the protruding portion on the front side of the vehicle.

8. A vehicle mounted with the vehicle drive device according to claim 1, wherein
the side member is disposed on an outer side of the protruding portion on each of the width direction sides of the vehicle.

9. A vehicle mounted with the vehicle drive device according to claim 1, wherein
the brake booster is disposed behind the protruding portion on the rear side of the vehicle.
